(19) United States
(12) Patent Application Publication
(10) Pub. No.: US 2010/0095232 A1
(43) Pub. Date: Apr. 15, 2010

(54) CALCULATING AND PLOTTING STATISTICAL DATA

(75) Inventor: Lawson H. Ramsay, Camelon (GB)

Correspondence Address: CONLEY ROSE, P.C.;David A. Rose, P. O. BOX 3267, HOUSTON, TX, 77253-3267, US

(73) Assignee: DANIEL MEASUREMENT AND CONTROL, INC., Houston, TX (US)

(21) Appl. No.: 12/251,594

(22) Filed: Oct. 15, 2008

(51) Int. Cl. G06F 3/048; G06F 17/18

(52) U.S. Cl. 715/769; 702/179

(57) ABSTRACT

Calculating and plotting statistical data in a control system. At least some of the illustrative embodiments are a systems comprising a flow computer configured to monitor a physical process external to the processing unit, a historian unit coupled to the flow computer by way of a computer network (the historian unit configured to receive data regarding the physical process, and configured to store the data in a nonvolatile storage device), and a human/machine interface (HMI) coupled to the historian unit by way of the computer network. The HMI is configured to retrieve historical data values regarding the physical process from the historian unit, calculate statistical data not held in the historian unit, the calculation based on the historical data values, and plot the statistical data on a display device.

### BACKGROUND

Control systems control a variety of industrial processes. For example, a control system may control a power plant, a hydrocarbon processing facility, or a baked goods processing facility. Regardless of the type of industrial plant controlled, in addition to the computer systems that execute to the control algorithms, the control system may also comprise one or more computer systems that act as a historian unit, gathering data and storing data values regarding the controlled process.

With increasing size and/or complexity of the controlled process, the amount of data gathered and stored by the computer systems operating as historian units may be tremendous. Thus, any technology which reduces the amount of data that may need to be stored in historian units and/or increases the functionality associated with the historical information, would provide a competitive advantage to a distributed process control system manufacturer.

### BRIEF DESCRIPTION OF THE DRAWINGS

For a detailed description of exemplary embodiments, reference will now be made to the accompanying drawings in which:

FIG. 1 shows a control system in accordance with at least some embodiments;

FIG. 2 shows graphically an illustrative mechanism to configure a historian unit in accordance with at least some embodiments;

FIG. 3 shows graphically an illustrative mechanism to inform an interface machine of the statistical calculation desired;

FIG. 4 shows a scattered diagram of illustrative statistical data;

FIG. 5 shows a histogram of illustrative statistical data;

FIG. 6 shows a computer-implemented method in accordance with at least some embodiments;

FIG. 7 shows a processing unit in accordance with at least some embodiments; and

FIG. 8 shows a system in accordance with alternative embodiments.

### NOTATION AND NOMENCLATURE

Certain terms are used throughout the following description and claims to refer to particular system components. As one skilled in the art will appreciate, distributed process control companies may refer to a component by different names. This document does not intend to distinguish between components that differ in name but not function.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices and connections.

“Data mining” shall mean statistical and/or logical analysis of data sets to determine relationships between different streams of parameters of a physical process.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

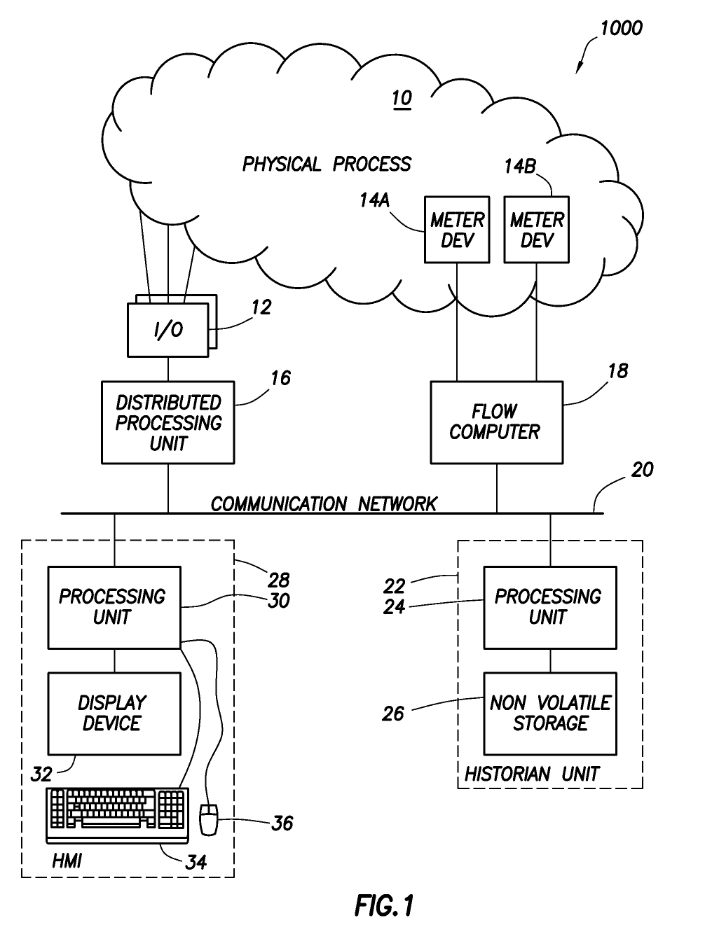

FIG. 1 shows a control system 1000, in accordance with at least some embodiments, coupled to a physical process 10. The physical process 10 may be any physical process which utilizes a control system to direct and manage the process. For example, the controlled physical process 10 may be a hydrocarbon metering facility (i.e., for purposes of billing and/or custody transfer), the various subsystems of power plant, the various subsystems of a hydrocarbon processing facility, or the various ovens, conveyors and mixers of a food processing plant. Regardless of the precise nature of the physical process 10, and if present, the various temperature transmitters, pressure transmitters, valve positioners, valve position indicators, and motor control systems couple to the illustrative input/output (I/O) devices 12 of the control system.

Still referring to FIG. 1, the control system 1000 may comprise one or more distributed processing units. In the illustrative case of FIG. 1, distributed processing unit 16 is specifically shown; however, any number of distributed processing units may be used depending on the size and complexity of the physical process 10, and flow computer 18 (discussed below) may likewise be considered a processing unit. In accordance with a distributed process control philosophy, each distributed processing unit 16 may be placed physically close to its directly coupled I/O devices 12. Moreover, each distributed processing unit 16 may also be placed physically close to the particular portion of the physical process 10 for which each distributed processing unit 16 is responsible. In the illustrative case of a power plant under the control of control system 1000, a distributed processing unit, such as distributed processing unit 16 and its related I/O devices 12, may be responsible for boiler control, and thus the distributed processing unit 16 may be physically placed near the boiler. Likewise, in the illustrative case of a power plant, the illustrative distributed processing unit 16 and related I/O devices 12 may be responsible for turbine control, and thus may be placed near the turbine, such as in the turbine building.

Each distributed processing unit 16 executes control software relevant to its portion of the physical process 10. The control software may implement Boolean-based control schemes (sometimes implemented as “ladder logic”), or the control software may implement closed-loop control of a process, such as one or more proportional-integral-differential (PID) control loops. In yet still other embodiments, the control software may implement neural-network-based control of the physical process 10. Beyond controlling portions of the physical process 10, the distributed processing units 16, 18 may also execute programs that perform calculations such as water flow, steam flow, and gas flow, and these calculated values may be stored for later viewing and/or become input, feedback or feed-forward parameters used in the control software as executed in the distributed processing unit 16. The distributed processing unit 16 may be, for example, a DeltaV™ MD Controller available from Emerson Process Management of St. Louis, Mo.

Still referring to FIG. 1, while some distributed processing units are generic, in the sense the distributed processing unit can be programmed to monitor and control a wide variety of physical processes, flow computer 18 is an example of processing unit designed for a particular task. In particular, flow computer 18 may be specifically designed and constructed to interface with various meter devices 14A and 14B monitoring the physical process 10. The meter devices 14 may be, for example, ultrasonic flow meters, or the various pressure and temperature transmitters associated with an orifice plate used for flow calculations. In the case of an orifice plate, the flow computer 18 may read the various transmitters and calculate fluid flow through the orifice. In the case of ultrasonic flow meters, the flow computer 18 may read the instantaneous flow rate determined by the ultrasonic meter. In some embodiments (e.g., where the meter devices 14 are exclusively ultrasonic flow meters), the flow computer 18 may be omitted, and the meter devices in the form a ultrasonic flow meters may directly coupled to the communication network and thus may likewise be considered processing units. Whether coupled to an orifice plate, an ultrasonic flow meter, or both, the illustrative flow computer 18 may also accumulate (sum) measured flow over any suitable period of time. Moreover, the flow computer 18 may implement various alarm conditions (e.g., high and low flow alarms, over pressure alarms), and may further control valves to selectively place in service or remove from service meter runs (e.g., as a function of total flow). The flow computer 18 may be, for example, a Daniel® S600 Flow Computer available from Emerson Process Management. Moreover, the meter devices 14 in their many forms may also be available from Emerson Process Management. Thus, the physical process controlled by the control system 1000 may be as complex as an entire industrial facility, or just the various devices of a metering subsystem.

In most situations, the data values monitored or calculated by a particular distributed processing unit, and likewise driven output values, are associated with the locally attached devices (i.e., I/O devices 12 in the case of illustrative processing unit 16, and meter devices 16 in the case of illustrative flow computer 18). However, the processing unit 16 and flow computer 18 may communicate with each other, and other devices, over the communication network 20. Thus, data values may be exchanged between the processing units to assist in performing assigned tasks related to the physical process 10. In accordance with at least some embodiments, the communication network 20 is an Ethernet-type network (i.e., Ethernet defining the physical and data link layers of the OSI model), with the precise protocol used for information exchange (i.e., layers above the data link layer of the OSI model) based on the particular system vendor. Stated otherwise, while most control systems utilize an Ethernet-based communication network 20, each vendor may utilize a proprietary high level protocol suited for the vendor's particular hardware and configuration.

Still referring to FIG. 1, most users of a control system also want or need historical data values associated with the physical process 10. In accordance with the various embodiments, a historian unit 22 is part of the control system 1000, and the historian unit 22 is responsible for gathering and maintaining historical data values regarding the physical process 10. In particular, the historian unit 22 may comprise a processing unit 24, which may be similar in form and construction to the distributed processing unit 16, but may execute different application programs and/or a different operating system. Coupled to the processing unit 24 is a non-volatile storage unit 26, within which the historical data values are placed. In accordance with at least some embodiments, the non-volatile storage is a hard disk drive, or possibly an array of hard disk drives operated in a fault tolerant fashion, such as a redundant array of inexpensive disks (RAID) system. In yet still other illustrative embodiments, the non-volatile storage may be any currently available or after-developed technology within which data may be stored in a non-volatile fashion, such as optical storage mediums and devices. In yet still other embodiments, the non-volatile storage 26 may comprise a plurality of different storage devices, such as a plurality of hard disk drives for more recent historical data values, and optical drives or tape drives for archived data values that are less frequently accessed.

In some embodiments, the historian unit 22 gathers the historical data values by polling the processing units, such as illustrative distributed processing unit 16 and flow computer 18. In other embodiments, the processing units are programmed to periodically send select data values to the historian unit 22. For example, data values for slowing moving process parameters may be sent by the processing units to the historian unit 22 every minute or more, while parameters whose values change quickly may be sent to the historian unit 22 with significantly shorter time spans (e.g., two seconds or less).

The illustrative control system 1000 of FIG. 1 also comprises a human/machine interface (HMI) 28. As the name implies, the human/machine interface 28 may be the mechanism by which a user interfaces with the remaining equipment of the control system 1000. For example, the human/machine interface 28 may be the mechanism by which the control loops executed in the distributed processing unit 16 are initialized and associated with appropriate I/O device inputs and outputs. Likewise, the human/machine interface 28 may be the mechanism by which the various parameters used by the flow computer 18 are set and modified. Further still, the human/machine interface 28 may be the mechanism by which an operator monitors and controls the physical process 10 (e.g., making set point adjustments, monitoring alarm values, changing valve positions). Further still, the human/machine interface 28 may be the mechanism by which a process engineer monitors trends of the physical process 10, and perhaps based on those trends makes changes to the tuning parameters or control strategy executed by control software of the distributed processing unit 16.

The human/machine interface 28 may comprise a processing unit 30, which may be similar in form and construction to the processing unit 24 of the historian unit 22. The processing unit 30 may differ from the other processing units by the type and number of application programs and/or a different operating system. Processing unit 30 couples to a display device 32, such as a cathode ray tube (CRT) or liquid crystal display (LCD) display. Finally, the human/machine interface 28 may have a keyboard 34 and the pointing device 36 coupled thereto, to enable a user to interface with the application programs executing on the processing unit 30.

The human/machine interface 28 may be the mechanism by which a process engineer or other interested person views graphical representations of the physical processor 10 on the display device 32. The human/machine interface 28 may also be the mechanism by which the interested person obtains historical data valves from the historian unit 22 and produces trends or plots of one or more streams of data values on the display device 32. For example, a process engineer may request that the human/machine interface 28 produce a plot as a function of time of natural gas flow at some relevant portion of the physical process 10 (e.g., natural gas flow through a particular meter run of a set of parallel meter runs). The human/machine interface 28 makes a request for the data valves from the historian unit 22, and when the data is returned the human/machine interface 28 plots as a function of time of the illustrative natural gas flow on the display device 32.

In alternative embodiments, the programs that implement the human/machine interface functionality may be included on the historian unit 22, thus eliminating the need for separate human/machine interfaces and historian units 22. Such a combination may be particularly suited to limited complexity physical processes, such as when the control system 1000 is used in metering and monitoring of hydrocarbon flows.

In the related art, to the extent a user, such as a process engineer, wants to plot statistical data, the statistical data must be a data point for which the historian unit 22 stores historical data values. Stated otherwise, in the related art any parameter (statistical or otherwise) for which a user would like to see a trend plotted on the display device 32 requires historical data values for the parameter to reside in the historian unit 22. To the extent that the parameter is not a direct representation of a monitored or driven parameter of the physical process 10, in the related art the parameter is created based on the monitored and/or driven parameters of the physical process 10 (e.g., using a function block executing in the distributed processing unit 16), and the parameter stored as a stream of data values of the data point within the historian unit 22. Such an operating philosophy tends to increase the size of the historical database managed by the historian unit 22, and which size directly affects the speed at which the historian unit 22 operates, and the number and size of devices that implement the non-volatile storage 26.

In accordance with the various embodiments, the shortcomings noted with respect to the related art are addressed, at least in part, by a system that calculates statistical data based on streams of historical data values from the historian unit 22, without requiring the historian unit to actually store the statistical data. When a user wishes to view and/or analyze statistical data related to the physical process 10, the user makes a request for calculation of the statistical data by way of the human/machine interface 28. The historical data values are retrieved, the statistical data is calculated at any suitable location (e.g., the human/machine interface 28 or the historian unit 22), and the statistical data is presented on the display device 32 of the human/machine interface 28 (e.g., a bell curve, a scatter diagram, a plot as a function of time or other parameter). In this way, the amount of data stored in the historian unit 22 may be less than if the desired statistical data is stored as a stream of data values for a data point in the historian unit 22. Moreover, the user is not limited to only statistical data that happens to be stored in the historian unit 22, as suitable statistical data related to the monitored and/or driven parameters of the physical process 10 may be requested and displayed on the display device 32. The specification first discusses an illustrative mechanism to inform the human/machine interface 28 of the desired statistical data, and then the specification turns to a plurality of illustrative statistical calculations which may be implemented.

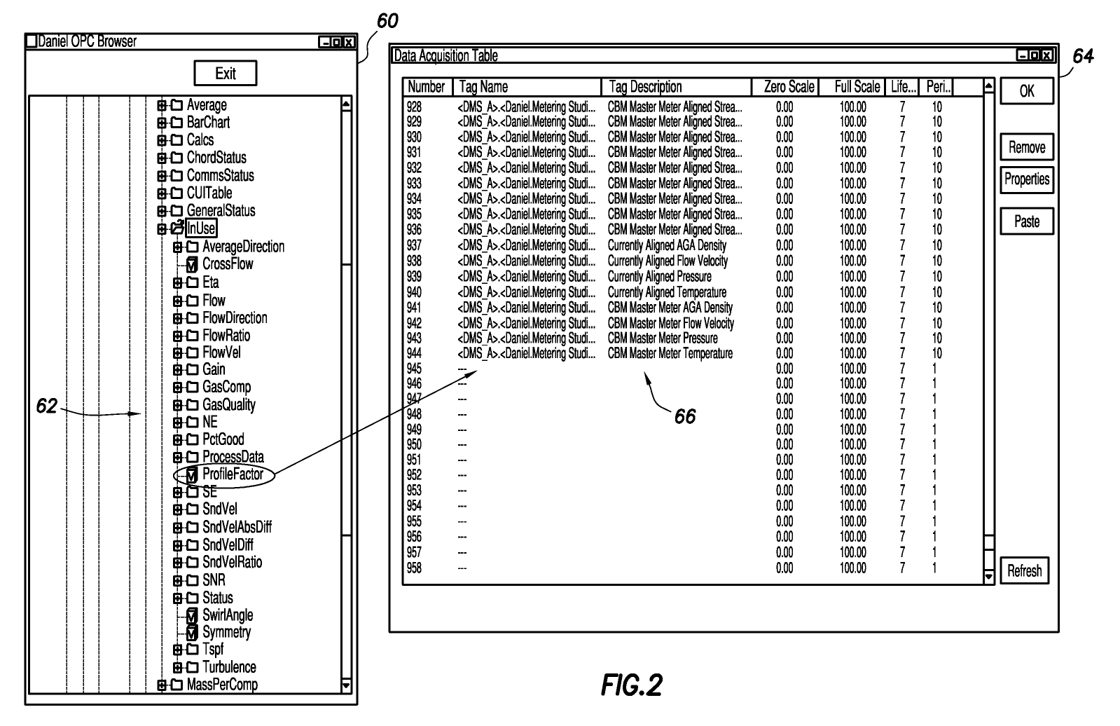

FIG. 2 shows “drag and drop” configuration of the historian unit 22 in accordance with at least some embodiments. In particular FIG. 2 illustrates, in the left window 60, a list of parameters 62 of the physical process 10 which, if the user desires, may be stored or “historized” in the historian unit 22. The right window 64 shows a list of data points 66 that have been selected such that the historian unit 22 will maintain a stream of historical data values for each selected data point. Moreover, the combined left window 60 and right window 64 illustrate a “drag and drop” mechanism to select a particular data point to be stored in the historian unit 22. In the case of FIG. 2, the parameter “profile factor,” which is an indication of the relative flow velocity of a fluid within a pipe at different elevations, is selected (such as by a click-and-hold on pointing device 36) and the illustrative profile factor data point is drug to the right window 64 where it is then “dropped” (such as by release of the pointing device button) into the right window 64. This “drag and drop” technique thus selects the particular data point to be tracked by the historian unit 22. Software to perform the “drag and drop” configuration of a historian unit 22 may be available for many sources, such as Emerson Process Management. In accordance with at least some embodiments, the “drag and drop” configuration technique of the historian unit 22 may take place by combination of software executed on the human/machine interface 28 communicating with software executed on the historian unit 22.

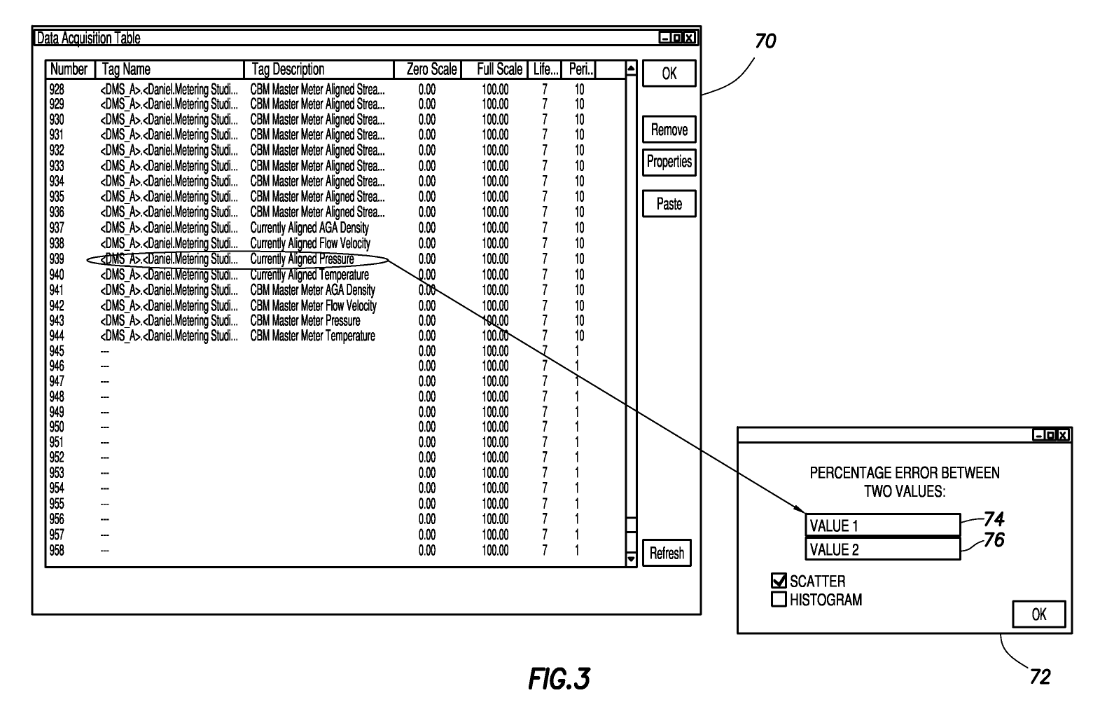

In accordance with the various embodiments, the calculation and plotting of statistical data may be configured using a “drag and drop” method similar to that discussed with respect to FIG. 2. In particular, FIG. 3 shows a plurality of windows to illustrate the configuration of calculation of statistical data in accordance with at least some embodiments. The upper left window 70 shows a plurality of data points for which the historian unit 22 maintains historical data values. The lower right window 72 illustrates a blank form window used to inform the human/machine interface 28 of the statistical data desired. More particularly still, and in accordance with at least some embodiments, a user of the human/machine interface 28 selects from a list of possible statistical calculations. Each possible statistical calculation is associated with a form window where the various data points to be used in the statistical calculation may be identified by the user. In the illustrative case of FIG. 3, the form window 72 is for the illustrative case of calculation of a percentage error between two data points. A user may then “drag and drop” a data point from the window 70 to the first value field 74 of window 72 (as shown by the arrow). Thereafter, a user may select another data point from the window 70 and “drag and drop” the data point to the second field 76 of window 72. After informing the human/machine interface 28 of the data point selections for the illustrative percentage error calculation, the human/machine interface 28 may retrieve the historical data values regarding the selected data points related to the physical process, the retrieval from the historian unit 22 by communication over the communication network 20 (of FIG. 1). Once the historical data values are received by the human/machine interface 28, the human/machine interface 28 may calculate the illustrative statistical data being percentage error using substantially the following equation:

Percentage error (%)=((Value 1−Value 2)/Value 1)*100 (1)

where Percentage Error is the percentage error between two corresponding values of the selected data points (e.g., data values corresponding in time), Value 1 is a particular data point placed within field 74, and Value 2 is a particular data point placed in the field 76. Stated otherwise, the human/machine interface 28 calculates a plurality of percentage error values based on the two streams of historical data values, and where those streams of historical data values are associated with either monitored, driven or calculated parameters of the physical process 10. Based on the calculations, the human/machine interface 28 plots the plurality of percentage error values in some form.

In the embodiments discussed to this point, the human/machine interface 28 retrieves the historical data values and performs the calculation of the statistical data desired. However, in other embodiments, the human/machine interface 28 may accept from the user an identification of the statistical data to be calculated (e.g., by selection of a form window for the particular calculation) and further the human/machine interface 28 may accept from the user the indications of the data points to be used in the calculations. However, in the alternative embodiments the human/machine interface 28 does not itself calculate the statistical data. Rather, the human/machine interface 28 communicates the desired statistical calculation and the data points to be used to the historian unit 22. The historian unit 22 retrieves the historical data valves associated with the indicated data points, calculates the statistical data requested, and then sends to the human/machine interface 28 the statistical data to be displayed on the display device 32. Stated otherwise, and from the perspective of the human/machine interface 28, the human/machine interface 28 receives from the user a request to calculate statistical data (where that statistical data is not tracked in the historian unit 22). The human/machine interface 28 sends the request regarding the calculation of statistical data to the historian unit 22. Thereafter, the human/machine interface 28 receives the statistical data from the historian unit 22 and plots the statistical data on the display device 32.

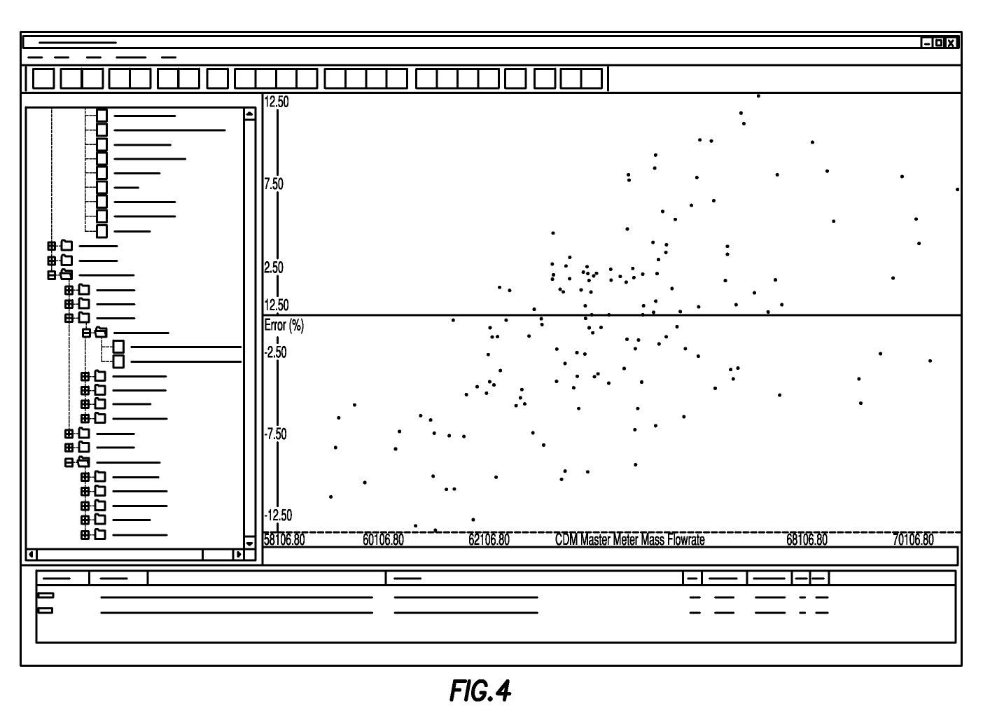

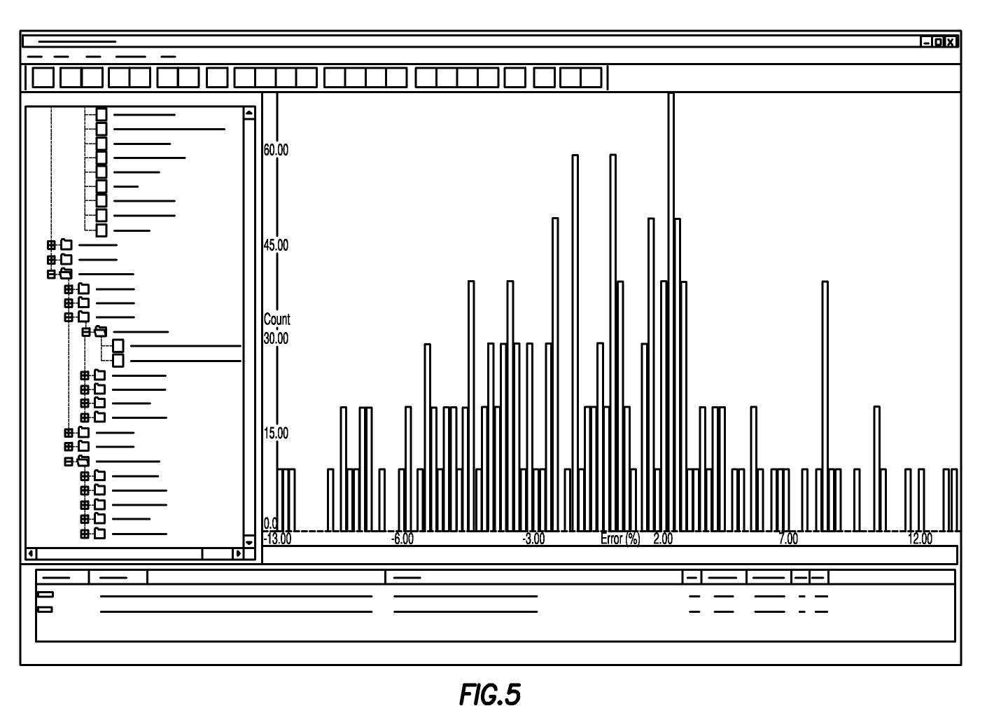

Regardless of the precise location where the statistical data is calculated, a user of the system is able to view and analyze the statistical data in spite of the fact that the statistical data is not a data point for which the historian unit 22 maintains historical data values. FIG. 4 shows a plot of statistical data in accordance with at least some embodiments, and in the particular case of FIG. 4 the plot of percentage error values in the form of a scatter diagram. FIG. 5 also illustrates a plot of percentage error values between two data points; however, in the illustrative case of FIG. 5 the data is plotted as a histogram. Informing the human/machine interface 28 to plot the illustrative percentage error as the histogram may be similar to that with respect to the percentage error values as a scatter diagram, except that a different blank form window may be used for scatter as opposed to histogram plotting, or, as illustrated in FIG. 3, the plotting mechanism may be selectable within the form window 72.

The discussion to this point speaks of statistical data in general, and gives a particular example of calculating percentage error. However, calculation of percentage error is merely illustrative, as there are many statistical calculations that may be applied to historical data values held in the historian unit 22 which may be useful to a user of the human/machine interface 28. The specification now turns to further, though still non-limiting, examples of the statistical data which may be calculated in accordance with the various embodiments.

One illustrative example of statistical data which may be calculated in accordance with the various embodiments is the calculation of the standard deviation of a stream of historical data values held in the historian unit 22. In particular, and regardless of precisely where calculated, the standard deviation of a monitored, driven or calculated parameter may be calculated within any specified start and stop date and/or time. In yet still other embodiments, the illustrative standard deviation may be calculated over a moving window of historical data values, and the standard deviation calculated may be plotted on the display device 32. A high standard deviation for a parameter of the physical process 10 may indicate a shortcoming or difficulty in the physical process 10 that average values would not necessarily show. In other cases, a high standard deviation may indicate the impending failure of a monitoring device (e.g., a temperature transmitter, pressure transmitter).

As yet another example of statistical data which may be calculated, and regardless of the precise location where the calculation is performed, the mean of a set of historical data values within any specified start and stop date and/or time may be calculated, and in some cases the mean may be calculated within a moving window.

As yet another example, the statistical data may be a statistical estimation of unknown values of the physical process 10 using a stream of historical data values. The estimation of an unknown value may take place within any specified start and stop date and/or time, or the statistical estimation may take place over a moving window of data values. Although any statistical estimation technique may be used to estimate the unknown values of the physical process 10, in accordance with at least some embodiments the estimation may implement any of a plurality of systems to reduce error in the calculation. For example, the statistical estimation may use Bayes estimators and method-of-moments estimators. Further, other error reduction techniques may be implemented, such as maximum a posteriori (MAP), minimum variance unbiased estimators (MVUE), best linear unbiased estimators (BLUE), Markov Chain Monte Carlo (MCMC), Kalman Filters, Ensemble Kalman Filters (EnKF), Wiener Filters, and other statistical estimation techniques. An illustrative example of a statistical estimation is the situation of two parallel metering streams. If in most situations when the metering streams are operating properly there is a 45%/55% split of flow between the two metering streams, then in the event of a failure of one of the metering streams a statistical estimation may be made for the unknown values of flow through the failed metering stream.

As yet another example of the statistical data, data mining may be performed based on the historical information associated with two or more data points maintained in the historian unit 22. The data mining may determine whether any relationship exist between the plurality in different streams of historical data values.

As yet another example of the statistical data, in accordance with at least some embodiments the Pearson Product-Moment correlation may be calculated between corresponding values for any two data points maintained by the historian unit 22.

As yet another example of the statistical data that may be calculated, for any stream of data values associated with a data point maintained by the historian unit 22, a linear and/or non-linear regression analysis may be performed. For example, the analysis may include least-square curve fitting by using linear regression, Bayesian linear regression, minimization of absolute deviations, quintile regressions, and non-parametric regression, all from a specified start and stop date and/or time or within a moving window of values.

As yet another example of statistical data that may be calculated, the statistical calculation may comprise an analysis of variance (ANOVA) from within a specified start and stop date and/or time or within a moving window of values.

As yet another example of the statistical data that may be calculated, time series forecasting, in either the frequency or the time-domain, may be performed to forecast future values related to the historical data values held within the historian unit 22.

As a final set of examples, the statistical data may further comprise standardization testing, including calculations such as standard deviation, cumulative percentages, percentile equivalence, Z-scores, T-scores, standard 9's and percentages in standard 9's, all calculated from within a specified start and stop date and/or time, or within a moving window of values.

As illustrated by the discussion above, substantially any statistical calculation which may reveal information of interest to the user may be implemented in accordance with the various embodiments.

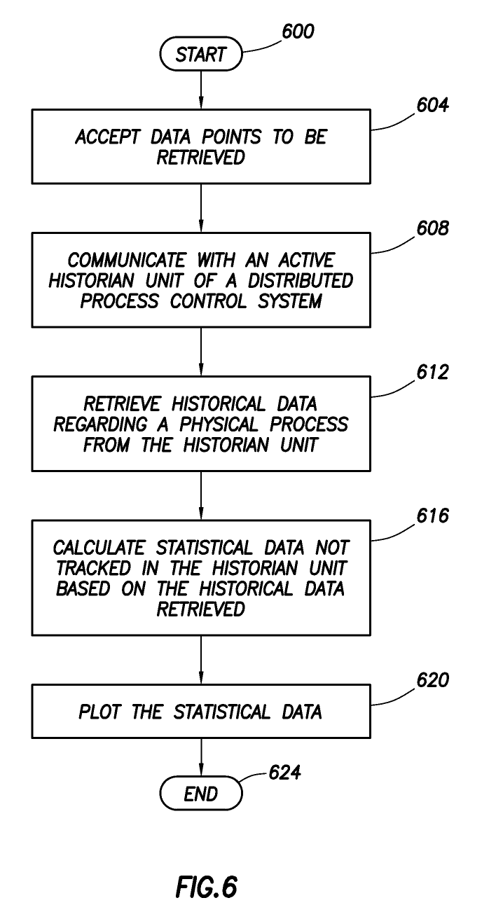

FIG. 6 illustrates a computer implemented method in accordance with at least some embodiments. In particular, the method may be implemented by human/machine interface 28. The method starts (block 600) and proceeds to the processor accepting data points to be retrieved (block 604). In at least some embodiments, data points are accepted by enabling the user to, by way of a graphical user interface, drag the data points from a first window and drop the data points into the second window. Next, the processor communicates with an active historian unit of a distributed process control system (block 608). Based on the communication (block 608), the computer-implemented method retrieves historical data regarding a physical process from the historian unit (block 612). After retrieving the historical data, the computer-implemented method calculates statistical data based on the historical data values received, where the statistical data is not tracked in the historian unit (block 616). The particular type of statistical data may vary in each implementation. For example, the statistical data may be a stream of percentage error values based on two streams of data values from the historian unit 22. In other embodiments, the statistical data may be a standard deviation of a stream of data values from the historian unit 22. In yet still in other embodiments, the statistical data may be the estimation of a series of unknown values of a physical process using a series of known data values of the physical process from the data retrieved from the historian unit 22. In yet still other embodiments, the statistical data may be the result of data mining on data values retrieved from the historian unit 22. In any of the illustrative embodiments, portions of the historical data values may be marked to be ignored in calculating the statistical data when the physical system makes such historical data values unusable, even if present.

Regardless of the precise statistical data calculated, after calculation of the statistical data the computer-implemented method may plot the statistical data on a display device (block 620) and thereafter the method ends (block 624). While FIG. 6 is illustrative of the human/machine interface 28 performing the calculation of the statistical data, in other embodiments the historian unit 22 performs the calculation. Retrieval of the historical data (block 612) and calculation of the statistical data (block 616) may be omitted from the human/machine interface 28, and the historian unit 22 performs the calculation of the statistical data (block 616).

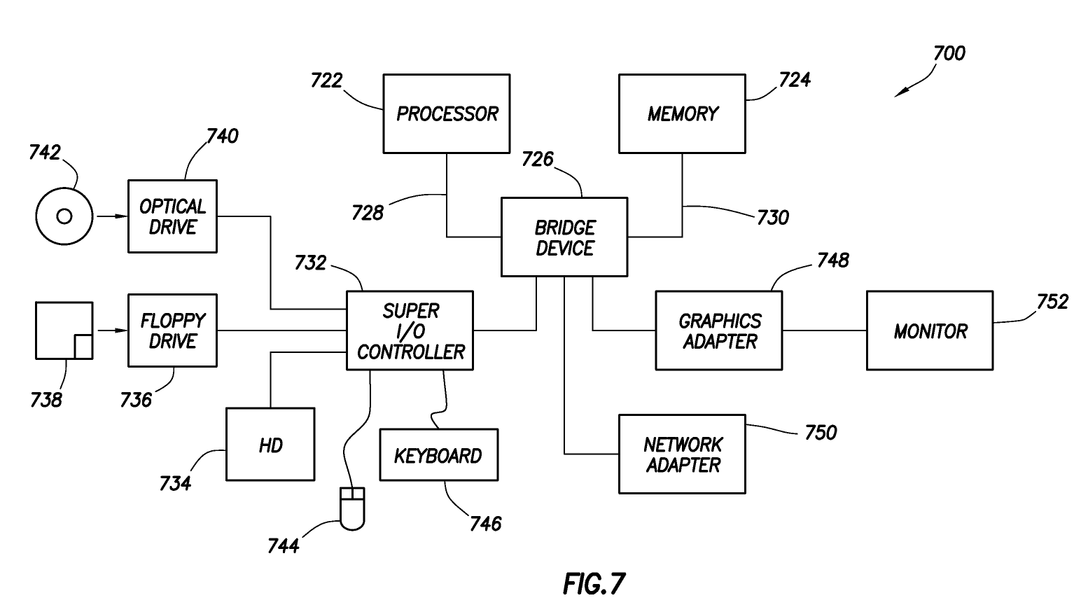

FIG. 7 illustrates a processing unit 700 in accordance with at least some embodiments. The processing unit 700 could be any of the processing units of FIG. 1, such as the distributed processing unit 16, the processing unit 30 (associated with the human/machine interface 28), the processing unit 24 (associated with the historian unit 22), or the flow computer 18. In particular, the processing unit 700 comprises a processor 722 coupled to a memory device 724 by way of a bridge device 726. Although only one processor 722 is shown, multiple processor systems, and system where the “processor” has multiple processing cores, may be equivalently implemented. The processor 722 may be any currently available or after-developed processor, such as processors available from AMD of Sunnyvale, Calif., or Intel of Santa Clara, Calif.

The processor 722 couples to the bridge device of 726 by way of a processor bus 728, and memory 724 couples to the bridge device 728 by way of a memory bus at 730. Memory 724 is any volatile or any non-volatile memory device, or array of memory devices, such as random access memory (RAM) devices, dynamic RAM (DRAM) devices, static DRAM (SDRAM) devices, double-data rate DRAM (DDR DRAM) devices, or magnetic RAM (MRAM) devices.

The bridge to 726 comprises a memory controller and asserts control signals for reading and writing of the memory 724, the reading and writing both by processor 722 and by other devices coupled to the bridge device 726 (i.e., direct memory access (DMA)). The memory 724 is the working memory for the processor 722, which stores programs executed by the processor 722 and which stores data structures used by the programs executed on the processor 722. In some cases, the programs held in the memory 724 are copied from other devices (e.g., hard drive 734, discussed below) prior to execution.

Bridge device 726 not only bridges the processor 722 to the memory 724, but also bridges the processor 722 and memory 724 to other devices. For example, the illustrative processing unit 700 may comprise an input/output (I/O) controller 732 which interfaces various I/O devices to the processing unit 700. In the illustrative processing unit 700, the I/O controller 732 enables coupling and use of non-volatile memory devices such as a hard drive (HD) 734, “floppy” drive 736 (and corresponding “floppy disk” 738), and optical drive 740 (and corresponding optical disk 742) (e.g., compact disk (CD), digital versatile disk (DVD)), a pointing device or 744, and a keyboard 736. In the case of processing unit 700 being a processing unit associated with the human/machine interface 28, the keyboard 746 and pointing device 744 may correspond to the keyboard 34 and pointing device 36, respectively, of FIG. 1. In situations where the processing unit 700 of FIG. 7 is a distributed processing unit 16, processing unit 24 associated with historian unit 22, or the flow computer 18, the keyboard 746 and pointing device 744 may be omitted. In the case of processing unit 700 being distributed processing unit 16 or flow computer 18, additionally the hard drive 734, floppy drive 736 and optical drive 740 may be omitted. Further still, in the case of processing unit 700 being the processing unit 24 associated with the historian unit 22, the I/O controller 732 may be replaced by a multiple drive controller, such as a drive controller for a RAID system.

Still referring to FIG. 7, the bridge device 726 further bridges the processor 722 and memory 724 to other devices, such as a graphics adapter 748 and network adapter 750. Graphics adapter 748, if present, is any suitable graphics adapter for reading display memory and driving a display device or monitor 752 with graphic images represented in the display memory. In some embodiments, the graphics adapter 748 internally comprises a memory area to which graphic primitives are written by the processor 722 and/or DMA rights between the memory 724 and the graphics adapter 748. The graphics adapter 748 couples to the bridge device 726 by way of any suitable bus system, such as peripheral components interconnect (PCI) bus or an advance graphics port (AGP) bus. In some embodiments, the graphics adapter 748 is integral with the bridge device 726. The human/machine interface 28 of FIG. 1 may comprise the graphics adapter, while the distributed processing unit 16, processing unit 24 (associated with the historian unit 22), and flow computer 18 may omit the graphics adapter.

Network adapter 750 enables the processing unit 700 to communicate with other processing units over the computer network 20 (FIG. 1). In some embodiments, the network adapter 750 provides access by way of a hardwired connection (e.g., Ethernet network), and in other embodiments the network adapter 750 provides access through a wireless networking protocol (e.g., IEEE 802.11(b), (g)).

As discussed above, when the illustrative processing unit 700 is associated with the human/machine interface 28, the processing unit 700 may be the computer through which a user interacts with the distributed processing unit 16 (e.g., to program the control loops related to the control physical process 10), flow computer 18, and also historian unit 22. Moreover, programs implemented and executed to perform the illustrative methods discussed above may be stored and/or executed from any of the computer-readable storage mediums of the illustrative processing unit 700 (e.g., memory 724, optical device 742, “floppy” device 738 or hard drive 734).

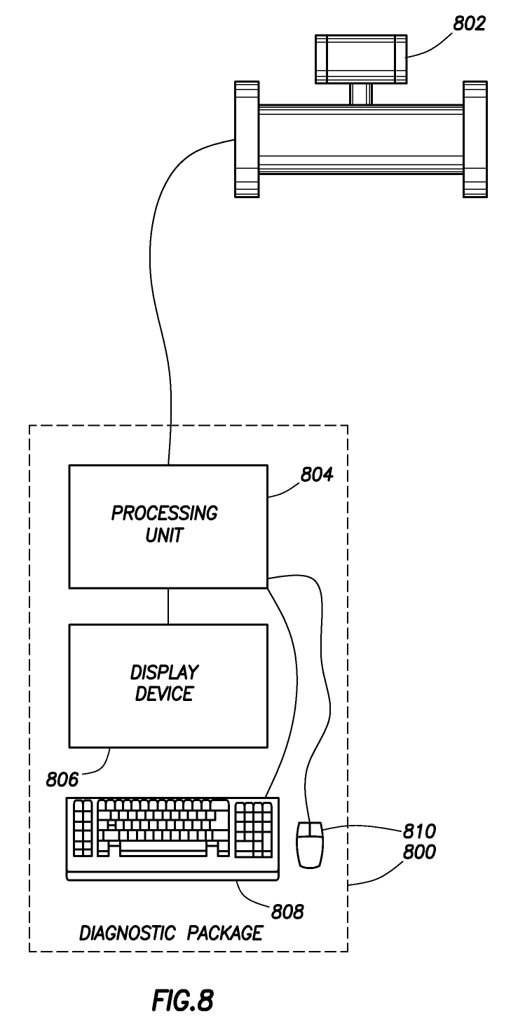

The various embodiments discussed to this point are in reference to a control system; however, the functionality of reduced data being held in a historian as historical data values, and calculating statistical data based the historical data values, may be used in any situation where a historian unit couples to a processing unit. FIG. 8 illustrates alternative embodiments where a diagnostic package 800 couples directed to an ultrasonic flow meter 802. In particular, the diagnostic package 800 may comprise a processing unit 804 directly (or locally) coupled to a display device 806, as well as a keyboard 808 and pointing device 810. Processing unit 804, which may be similar in form and construction to the processing unit 24 of the historian unit 22 (FIG. 1). The processing unit 804 in these alternative embodiments, and thus the diagnostic package 800, executes programs that perform a historian function with respect to a plurality of streams of data values from a physical process, in this illustrative case with respect to streams of data values generated by the ultrasonic flow meter 802. The illustrative ultrasonic flow meter 802 may produce data streams such as ultrasonic signal travel time between transducer pairs for a plurality of transducers, speed of sound measurements, as well as instantaneous flow through the ultrasonic flow meter 802. The ultrasonic flow meter 802 is merely illustrative of processing units to which a diagnostic package may be coupled, and other examples include flow computers and distributed processing units of control systems.

In addition to performing a historian function with the respect to data generated by the ultrasonic flow meter 802, and in accordance with at least some embodiments, the illustrative diagnostic package 800 may also receive from the user a request to calculate statistical data that is not maintained as historical data values. In the embodiments shown in FIG. 8, receiving the request to calculate the statistical data may be by way of the keyboard 808, pointing device 810 and display device 806, but in alternative embodiments receiving the request could be by a way of another processing unit coupled by way of a computer network. Moreover, the receiving of the request to calculate the statistical data could be by way of the drag-and-drop techniques discussed above.

Regardless of the precise mechanism by which the request is received, the statistical data is calculated by the diagnostic package 800. Thus, the embodiments of FIG. 8 expressly depict situations where the human/machine interface and historian are implemented in the same processing unit. Once the statistically data is calculated, the statistical data is plotted. In some cases the statistical data is plotted on the directly coupled display device 806. In other embodiments, the plot, or perhaps the statistical data itself, may be sent to a remotely coupled (i.e., by way of a non-internal computer network) display device and plotted at the remotely coupled display device. Any and all the illustrative statistical data mentioned above, as well as the plotting techniques, are equally applicable in the embodiments of FIG. 8.

From the description provided herein, those skilled in the art are readily able to combine software created as described with appropriate general-purpose or special-purpose computer hardware to create a computer system and/or other computer subcomponents in accordance with the various embodiments, to create a computer system and/or computer subcomponents for carrying out the methods for various embodiments, and/or to create a computer-readable storage medium or mediums for storing a software program to implement the method aspects of the various embodiments.

The above discussion is meant to be illustrative of the principles and various embodiments of the present invention. Numerous variations and modifications will become apparent to those skilled in the art once the above disclosure is fully appreciated. For example, the discussion and terminology above is based on distributed process control (DCS) systems; however, similar functionality is implemented in systems based on supervisory control and data acquisition (SCADA) units coupled to programmable logic controllers (PLCs), which may be known as SCADA systems. Systems using SCADA may comprise one or more SCADA units coupled to one or more PLC units over a backbone communication network. The PLC units control the physical process (e.g., discrete or Boolean control, and “continuous” control, such as proportion-integral-differential), and the SCADA units gather information about the physical process and provide supervisory control to a system user. Stated otherwise, once programmed, the PLC units act autonomously to control a portion or all the physical process, and the SCADA units store historical data and provide a window to the state of control that enables a user to make control changes (e.g., flow set point changes, level set point changes). Thus, it is seen that the functionality provided by a SCADA unit is very similar, if not identical, to the human/machine interface and historian units discussed above. Moreover, the functionality provided by a PLC is very similar, if not identical, to the distributed processing units discussed above. The differences in terminology between SCADA systems and DCS systems are, by and large, the industries to which the systems are applied. DCS system terminology is used in reference to industrial plants (e.g., hydrocarbon processing, power plants), and SCADA terminology is used in reference to factory automation. For purposes of this disclosure and claims, however, the inventive contributions discussed in this specification in terms of DCS systems are equally applicable to systems discussed under SCADA terminology, and thus the fact that a manufacturer refers to components by a different name (e.g., PLC rather than distributed processing unit, and SCADA rather than historian unit and/or human/machine interface) shall not obviate infringement. More broadly still, the inventive contribution is applicable to any SCADA, PLC, diagnostic and/or real time monitoring package that includes within its design a historian function. It is intended that the following claims be interpreted to embrace all such variations and modifications.

What is claimed is:

1. A system comprising:
a flow computer configured to monitor a physical process external to the processing unit;
a historian unit coupled to the flow computer by way of a computer network, the historian unit configured to receive data regarding the physical process, and configured to store the data in a nonvolatile storage device; and
a human/machine interface (HMI) coupled to the historian unit by way of the computer network, the HMI configured to:
retrieve historical data values regarding the physical process from the historian unit;
calculate statistical data not held in the historian unit, the calculation based on the historical data values; and
plot the statistical data on a display device.

2. The control system of claim 1 wherein when the HMI calculates the statistical data, HMI is configured to at least one selected from the group consisting of: calculate a plurality of percentage error values based on two streams of historical data values, each stream of historical data values associated with a monitored or driven parameter of the physical process; calculate a standard deviation of a stream of historical data values associated with a monitored or driven parameter of the physical process; estimate a stream of unknown values of the physical process using a stream of historical data values of the physical process in the historical data values retrieved; perform data mining on the historical data values.

3. The control system of claim 1 wherein HMI is further configured to accept data points to be used by dragging the data points from a first window and dropping the data points in a second window.

4. The control system of claim 1 wherein the historian unit and the human/machine interface are the same computer system.

5. A control system comprising:
a processing unit comprising:
a processor;
a memory coupled to the processor, the memory stores a control program that, when executed by the processor, causes the processor to monitor a physical process external to the processing unit;
a historian unit coupled to the processing unit by way of a computer network, the historian unit comprising:
a processor;
a nonvolatile storage device coupled to the processor;
a memory coupled to the processor, the memory stores a historian program that, when executed by the processor, causes the processor to receive data regarding the physical process, and to store the data in the nonvolatile storage device;
a human/machine interface (HMI) coupled to the historian unit by way of the computer network, the HMI comprising:
a display device;
a processor coupled to the display device;
a memory coupled to the processor, the memory stores a trending program that, when executed by the processor, causes the processor to:
retrieve historical data values regarding the physical process from the historian unit;
calculate statistical data not held in the historian unit, the calculation based on the historical data values; and
plot the statistical data on the display device.

6. The control system of claim 5 wherein the processing unit is at least one selected from the group consisting of: a flow computer coupled to metering devices; a distributed processing unit configured to implement control strategies within the physical process.

7. The control system of claim 5 wherein when the processor of the HMI calculates the statistical data, the trending program further causes the processor to calculate a plurality of percentage error values based on two streams of historical data values, each stream of historical data values associated with a monitored or driven parameter of the physical process.

8. The control system of claim 5 wherein when the processor of the HMI calculates the statistical data, the trending program further causes the processor to calculate a standard deviation of a stream of historical data values associated with a monitored or driven parameter of the physical process.

9. The control system of claim 5 wherein when the processor of the HMI calculates the statistical data, the trending program further causes the processor to estimate a stream of unknown values of the physical process using a stream of historical data values of the physical process in the historical data values retrieved.

10. The control system of claim 5 wherein when the processor of the HMI calculates the statistical data, the trending program further causes the processor to perform data mining on the historical data values.

11. The control system of claim 5 wherein, prior to calculating the statistical data, the trending program further causes the processor to determine whether particular historical data values are usable based on a configuration of the physical system, and to mark historical data values to be ignored in calculating the statistical data when the physical system makes the historical data values unusable.

12. The control system of claim 5 wherein the trending program further causes the processor to accept data points to be used by dragging the data points from a first window and dropping the data points in a second window.

13. The control system of claim 5 wherein the historian unit and the human/machine interface are the same device.

14. A control system comprising:
a processing unit comprising:
a processor;
a memory coupled to the processor, the memory stores a control program that, when executed by the processor, causes the processor to monitor a physical process external to the processing unit;
a historian unit coupled to the processing unit by way of a computer network, the historian unit comprising:
a processor;
a nonvolatile storage device coupled to the processor;
a memory coupled to the processor, the memory stores a historian program that, when executed by the processor, causes the processor to receive data regarding the physical process, and to store the data in the nonvolatile storage device;
a human/machine interface (HMI) coupled to the historian unit by way of the computer network, the HMI comprising:
a display device;
a processor coupled to the display device;
a memory coupled to the processor, the memory stores a trending program that, when executed by the processor, causes the processor to:
receive from a user a request to calculate statistical data not tracked in the historian unit, the request to calculate based on data regarding the physical process;
send a request regarding calculation of statistical data to the historian unit;
receive statistical data; and
plot the statistical data on the display device;
the historian program further causes the processor of the historian unit to calculate the statistical data and provide the statistical data to the HMI.

15. The control system of claim 14 wherein the processing unit is at least one selected from the group consisting of: a flow computer coupled to metering devices; a distributed processing unit configured to implement control strategies within the physical process.

16. The control system of claim 14 wherein when the processor of the historian unit calculates the statistical data, the historian program further causes the processor to calculate a plurality of percentage error values based on two streams of data values, each stream of data values associated with a monitored or driven parameter of the physical process.

17. The control system of claim 14 wherein when the processor of the historian unit calculates the statistical data, the historian program further causes the processor to calculate a standard deviation of a stream of data values associated with a monitored or driven parameter of the physical process.

18. The control system of claim 14 wherein when the processor of the historian unit calculates the statistical data, the historian program further causes the processor to estimate a series of unknown data values of the physical process using a series of known data values of the physical process in the data retrieved.

19. The control system of claim 14 wherein when the processor of the historian unit calculates the statistical data, the historian program further causes the processor to perform data mining on data values stored within the historian unit.

20. The control system of claim 14 wherein, prior to calculating the statistical data, the historian program further causes the processor to determine whether data values are usable based on a configuration of the physical system, and to mark data values to be ignored in calculating the statistical data when the physical system makes the data values unusable.

21. The control system of claim 14 wherein the trending program further causes the processor of the HMI to accept data points to be used by dragging the data points from a first window and dropping the data points in a second window.

22. The control system of claim 14 wherein the historian unit and the human/machine interface are the same device.

23. A computer-readable medium storing a program that, when executed by a processor, causes the processor to:
communicate with a historian unit;
retrieve historical data values regarding a physical process from the historian unit;
calculate statistical data not tracked in the historian unit based on the historical data values retrieved; and
plot the statistical data on a display device.

24. The computer-readable medium of claim 23 wherein when the processor calculates statistical data, the program further causes the processor to perform data mining on the historical data values.

25. The computer-readable medium of claim 23 wherein when the processor calculates the statistical data, the program further causes the processor to calculate a stream of percentage error values based on first stream of data values and a second stream of data values of the historical data values.

26. The computer-readable medium of claim 23 wherein when the processor calculates the statistical data, the program further causes the processor to calculate a standard deviation over a moving window of data values of a stream of data values of the historical data values.

27. The computer-readable medium of claim 23 wherein when the processor calculates the statistical data, the program further causes the processor to estimate unmeasured data values of the physical process using the historical data values.

28. The computer-readable medium of claim 23 wherein prior to when the processor calculates the statistical data, the program causes the processor to determine whether data values are valid based on a configuration of the physical system when the data values were stored, and to mark data values to be ignored in calculating the statistical data when the configuration of the physical system makes the data values unusable.

29. The computer-readable medium of claim 23 wherein when the processor calculates the statistical data, the program further causes the processor to accept data points to be retrieved by enabling a user to, a graphical user interface, drag the data points from a first window and drop the data points in a second window.

30. A system comprising:
a first processing unit configured to generate a plurality of streams of data values regarding a physical process, each stream of data values regarding a data point;
a second processing unit coupled to the first processing unit, the second processing unit configured to:
maintain historical data values for each data point;
receive from a user a request to calculate statistical data not maintained as historical data values, the request to calculate based on historical data values regarding the physical process; and
calculate the statistical data.

31. The system of claim 30 wherein the second processing unit is further configured to at least one selected from the group consisting of: send the statistical data to a remotely coupled display device; and plot the statistically data on a directly coupled display device.

32. The system of claim 30 wherein the first processing unit is at least one selected from the group consisting of; an ultrasonic flow meter; a flow computer; and a distributed processing unit of a control system.
